(19) United States
(12) Patent Application Publication
(10) Pub. No.: US 2024/0349199 A1
(43) Pub. Date: Oct. 17, 2024

(54) CHANNEL ESTIMATION ACCURACY IMPROVEMENT FOR SRS ANTENNA SWITCHING

(71) Applicant: Nokia Technologies Oy, Espoo (FI)

(72) Inventors: Hiromasa UMEDA, Tokyo (JP); Juha Pekka KARJALAINEN, Oulu (FI); Youngsoo YUK, Seoul (KR)

(21) Appl. No.: 18/627,679

(22) Filed: Apr. 5, 2024

Related U.S. Application Data
(60) Provisional application No. 63/459,869, filed on Apr. 17, 2023.

(51) Int. Cl. H04W 52/14; H04W 52/24

(52) U.S. Cl. CPC H04W 52/146; H04W 52/241

(57) ABSTRACT

A method including: determining, with a user equipment, an uplink transmission power control mode from at least two possible different uplink transmission power control modes for antenna ports of the user equipment, where the antenna ports comprise at least two antenna ports; and sending, to a network equipment, information regarding the determined uplink transmission power control mode.

### RELATED APPLICATION

This application claims priority to U.S. provisional Application No. 63/459,869 filed Apr. 17, 2023, which is incorporated herein by reference in its entirety.

### TECHNICAL FIELD

The example and non-limiting embodiments relate generally to transmission power control and, more particularly, to varying transmission power control for multiple antennas.

### BRIEF DESCRIPTION OF PRIOR DEVELOPMENTS

Transmission power performance requirements are known in regard to antenna switching.

### SUMMARY OF THE INVENTION

The following summary is merely intended to be an example. The summary is not intended to limit the scope of the claims.

In accordance with one aspect, an example method is provided comprising: determining, with a user equipment, an uplink transmission power control mode from at least two possible different uplink transmission power control modes for antenna ports of the user equipment, where the antenna ports comprise at least two antenna ports; and sending, to a network equipment, information regarding the determined uplink transmission power control mode.

In accordance with another aspect, an example apparatus is provided comprising: at least one processor; and at least one non-transitory memory storing instructions that, when executed with the at least one processor, cause the apparatus to perform: determining, with the apparatus, an uplink transmission power control mode from at least two possible different uplink transmission power control modes for antenna ports of the apparatus, where the antenna ports comprise at least two antenna ports; and sending, to a network equipment, information regarding the determined uplink transmission power control mode.

In accordance with another aspect, an example apparatus is provided comprising: means for determining, with a the apparatus, an uplink transmission power control mode from at least two possible different uplink transmission power control modes for antenna ports of the apparatus, where the antenna ports comprise at least two antenna ports; and means for sending, to a network equipment, information regarding the determined uplink transmission power control mode.

In accordance with another aspect, an example apparatus is provided with a non-transitory program storage device readable by an apparatus, tangibly embodying a program of instructions executable with the apparatus for performing operations, the operations comprising: determining, with the apparatus, an uplink transmission power control mode from at least two possible different uplink transmission power control modes for antenna ports of the apparatus, where the antenna ports comprise at least two antenna ports; and sending, to a network equipment, information regarding the determined uplink transmission power control mode.

In accordance with another aspect, an example method is provided comprising: determining respective insertion losses for a plurality of antenna ports of a user equipment, where at least two of the respective insertion losses are different; and sending, to a network equipment, information regarding the determined respective insertion losses for the plurality of antenna ports.

In accordance with another aspect, an example apparatus is provided comprising: at least one processor; and at least one non-transitory memory storing instructions that, when executed with the at least one processor, cause the apparatus to perform: determining respective insertion losses for a plurality of antenna ports of the apparatus, where at least two of the respective insertion losses are different; and sending, to a network equipment, information regarding the determined respective insertion losses for the plurality of antenna ports.

In accordance with another aspect, an example apparatus is provided comprising: means for determining respective insertion losses for a plurality of antenna ports of the apparatus, where at least two of the respective insertion losses are different; and means for sending, to a network equipment, information regarding the determined respective insertion losses for the plurality of antenna ports.

In accordance with another aspect, an example apparatus is provided with a non-transitory program storage device readable by an apparatus, tangibly embodying a program of instructions executable with the apparatus for performing operations, the operations comprising: determining respective insertion losses for a plurality of antenna ports of the apparatus, where at least two of the respective insertion losses are different; and sending, to a network equipment, information regarding the determined respective insertion losses for the plurality of antenna ports.

In accordance with another aspect, an example method is provided comprising: determining, with a network equipment, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the network equipment of a recommended power control mode, or select one of at least two different uplink transmission power control modes for use with the antenna ports; and sending, to the user equipment, the determined information.

In accordance with another aspect, an example apparatus is provided comprising: at least one processor; and at least one non-transitory memory storing instructions that, when executed with the at least one processor, cause the apparatus to perform: determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and sending, to the user equipment, the determined information.

In accordance with another aspect, an example apparatus is provided comprising: means for determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and means for sending, to the user equipment, the determined information.

In accordance with another aspect, an example apparatus is provided comprising: means for determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and means for sending, to the user equipment, the determined information.

In accordance with another aspect, an example apparatus is provided comprising: means for determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and means for sending, to the user equipment, the determined information.

In accordance with another aspect, an example apparatus is provided with a non-transitory program storage device readable by an apparatus, tangibly embodying a program of instructions executable with the apparatus for performing operations, the operations comprising: determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and sending, to the user equipment, the determined information.

In accordance with another aspect, an example method comprising: receiving, with a network equipment, a message from a user equipment regarding an uplink transmission power control method; and sending, with the network equipment, a response message to the user equipment regarding the received message.

In accordance with another aspect, an example apparatus is provided comprising: at least one processor; and at least one non-transitory memory storing instructions that, when executed with the at least one processor, cause the apparatus to perform: receiving, with the apparatus, a message from a user equipment regarding an uplink transmission power control method; and sending, with the apparatus, a response message to the user equipment regarding the received message.

In accordance with another aspect, an example apparatus is provided comprising: means for receiving, with the apparatus, a message from a user equipment regarding an uplink transmission power control method; and means for sending, with the apparatus, a response message to the user equipment regarding the received message.

In accordance with another aspect, an example apparatus is provided with a non-transitory program storage device readable by an apparatus, tangibly embodying a program of instructions executable with the apparatus for performing operations, the operations comprising: receiving, with the apparatus, a message from a user equipment regarding an uplink transmission power control method; and sending, with the apparatus, a response message to the user equipment regarding the received message.

In accordance with another aspect, an example method is provided comprising: sending a message to a user equipment, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and receiving a message from the user equipment indicating that the user equipment supports the established mode.

In accordance with another aspect, an example apparatus is provided comprising: at least one processor; and at least one non-transitory memory storing instructions that, when executed with the at least one processor, cause the apparatus to perform: sending a message to a user equipment, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and receiving a message from the user equipment indicating that the user equipment supports the established mode.

In accordance with another aspect, an example apparatus is provided comprising: means for sending a message to a user equipment, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and means for receiving a message from the user equipment indicating that the user equipment supports the established mode.

In accordance with another aspect, an example apparatus is provided with a non-transitory program storage device readable by an apparatus, tangibly embodying a program of instructions executable with the apparatus for performing operations, the operations comprising: sending a message to a user equipment, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and receiving a message from the user equipment indicating that the user equipment supports the established mode.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2A is a diagram illustrating UL SRS resource set configuration with usage of antenna-switching with 1T2R with aperiodic resource sets;

FIG. 2B is a diagram illustrating UL SRS resource set configuration with usage of antenna-switching with 1T2R with periodic/semi-persistent resource sets;

FIG. 3A is a diagram illustrating an example of antenna switching;

FIG. 3B is a table illustrating an example of parameters for antenna ports and antenna switching;

FIG. 4 is an example of channel estimation error due to ΔT_{RxSRS} for SRS antenna switching;

FIG. 5 is an example of possible UE behavior in terms of output power;

FIG. 6 is an example of usable areas for the respective output power mode options;

FIG. 7 is an example of UL SRS resource set configurations defined in TS 38.331;

FIG. 8 is an example of relationship of powers at between PA and antenna connector depending on modes (1T2R);

FIG. 9 is a diagram illustrating an example method;

FIG. 10 is a diagram illustrating an example method;

FIG. 11 is a diagram illustrating an example method;

FIG. 12 is a diagram illustrating an example method;

FIG. 13 is a diagram illustrating an example method.

### DETAILED DESCRIPTION

The following abbreviations that may be found in the specification and/or the drawing figures are defined as follows:
3GPP third generation partnership project
5G fifth generation
5GC 5G core network
AMF access and mobility management function
BWP bandwidth part
CSI channel state information
CE control element
CU central unit
DL downlink
DMRS demodulation reference signal
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FR frequency range
gNB (or gNodeB) base station for 5G/NR, i.e., a node providing NR user plane and control plane protocol terminations towards the UE, and connected via the NG interface to the 5GC
I/F interface
IL insertion loss
LS liaison statement
LTE1 long term evolution
MAC medium access control
MME mobility management entity
ng or NG new generation
ng-eNB or NG-eNB new generation eNB
NR new radio
N/W or NW network
PA power amplifier
PC power class
PDCP packet data convergence protocol
PDSCH physical data shared channel
PHR power head room
PHY physical layer
RAN radio access network
RAN4 3GPP working group relating to radio performance and protocol aspects
Rel release
Rel-15 release 15
Rel-18 release 18
RF radio frequency
RLC radio link control
RRH remote radio head
RRC radio resource control
RS reference signal
RU radio unit
Rx receiver or reception
SDAP service data adaptation protocol
SGW serving gateway
SMF session management function
SRS sounding reference signal
SS synchronization signal
TRX transmission and reception
TS technical specification
Tx transmitter or transmission
UE user equipment (e.g., a wireless, typically mobile device)
UL uplink
UPF user plane function
WI work item

Features as described herein may be used in regard to enhancing coverage and quality of uplink (UL) sounding reference signal (SRS) based DL CSI acquisition by introducing a new power control scheme. Background may be found, for example, in 3GPP Rel-18 WI of “Further RF requirements enhancement for NR and EN-DC in frequency range 1 (FR1)”, where performance requirements for UE with 8 Rx is one of the objectives.

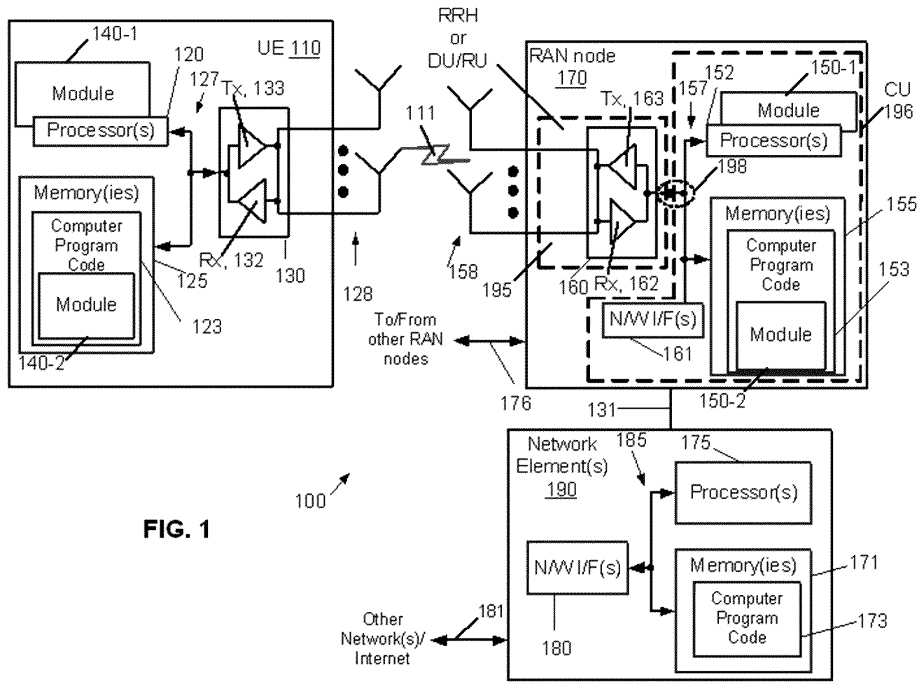

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

### Uplink Sounding Reference Signal (SRS) Configuration

3GPP Rel-15 RAN4 specification (TS 38.101-1) introduced performance requirements related to UL SRS resource configuration with antenna switching, where UEs equipped with 4 RX antenna ports were assumed, and depending on reported UE's antenna-switching capability, the UE can be configured with one of the following antenna-switching configurations: t1r2, t1r4, t2r4, t1r4-t2r4, t1r1, t2r2 and t4r4′, where “t” and “r” define the number of transmission antenna ports and reception antenna ports at the UE-side, respectively. It's noted that t “x” r “y” is denoted as xTyR in RAN1 language.

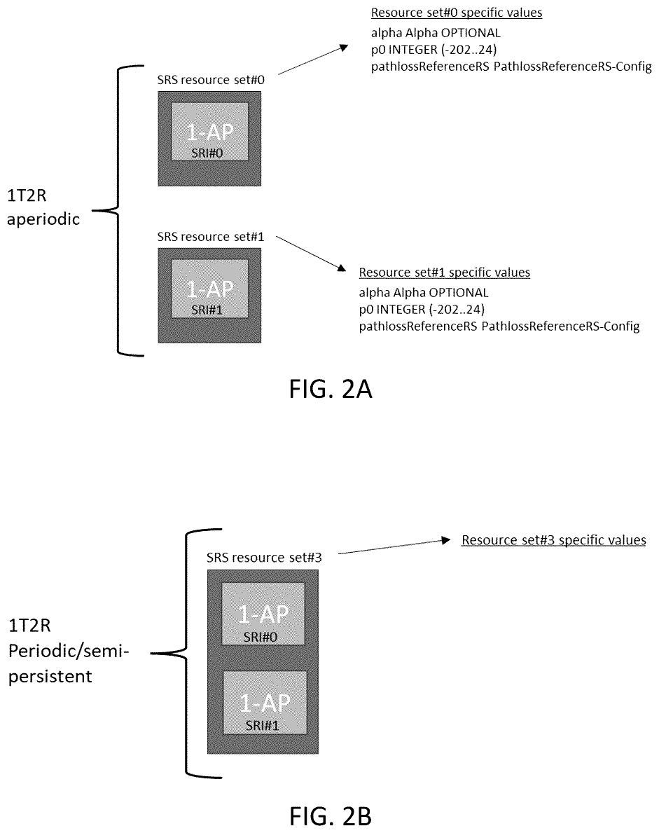

FIG. 2A shows an example of UL SRS resource set configuration with usage of antenna switching with 1T2R with aperiodic resource sets. FIG. 2A shows an example of UL SRS resource set configuration with usage of antenna switching with 1T2R with periodic/semi-persistent resource sets. When the UE is configured with aperiodic UL SRS resource sets, up to two (2) different resource sets can be configured for antenna switching with 1T2R. When the UE is configured with periodic resource sets, only one resource set can be configured for antenna switching with 1T2R. Each resource set can have its own following uplink SRS power control parameters; alpha (SRS power control), port 0 (nominal targeted RX power at gNB), pathlossReferenceRS (a reference signal (e.g. a CSI-RS config or a SS block) to be used for SRS path loss estimation).

RAN4 has identified an issue specifically for configurations whose “t” is less than “r”. The issue is that UEs cannot achieve an advertised maximum output power, i.e., power class (PC) from each antenna port due to routing loss in RF front end apart from the main antenna. (R4-1810553). As a result, TS 38.101-1 allows the UE to transmit output power relaxed by ΔT_{RxSRS}, e.g., 4.5 dB for n79 when the UE is capable of power class 3. It means that the respective output powers from other than main antenna port can be less than half of the output power from the main antenna port.

Further, in Rel-18, RAN4 has started introducing performance requirements for 8 Rx, where corresponding ΔT_{RxSRS} values have been discussed, while the proposed values are in some cases, e.g., 8 dB (R4-2301763) due to more complicated UE implementation with more switches, more routing loss specifically for CPE devices.

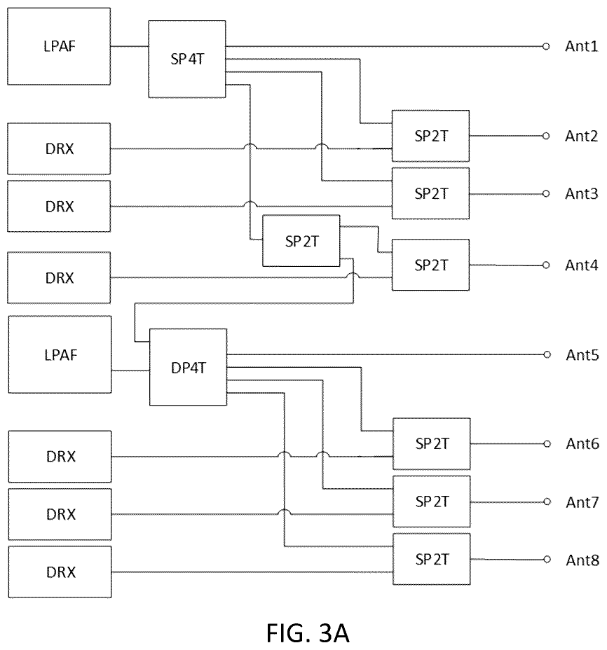

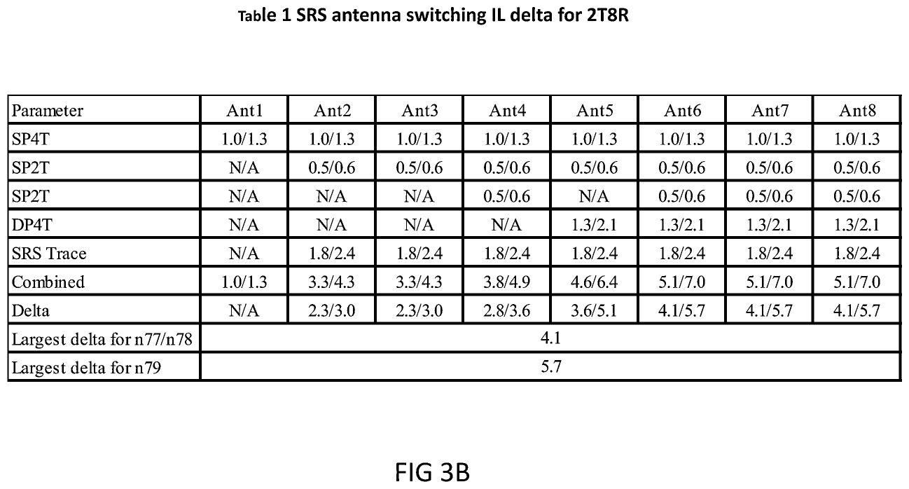

An example of ΔT_{RxSRS} values (“Delta”) can be seen in e.g., Table 9 in R4-2216347. Table 9 from R4-2216347 is shown in FIG. 3B, along with a diagram from 2.2.6 of R4-2216347 showing the antenna ports (Ant1, Ant2, etc.) shown in FIG. 3A. ΔT_{RxSRS} is maximum allowed performance degradation, i.e., output power reduction. In order to better understand the situation, assume that a UE's PC is 3 (23 dBm) with t1r2 support, and a UE's actual ΔT_{RxSRS} is 3 dB for 2nd antenna port. In this case, the output power per antenna port can be 23 dBm and 20 dBm, respectively. This output power imbalance due to ΔT_{RxSRS} brings large Channel estimation errors associated with UL SRS. Since when the UE receives DL signals from gNB, the ΔT_{RxSRS} may not exist (assuming that dedicated receiver branches are placed close to each antenna port for DL reception). Hence, without taking into account output power imbalance between antenna ports used for SRS transmission, channel estimation errors associated with UL SRS transmission with antenna switching at gNB-side lead to potential performance degradation in DL PDSCH transmission while using obtained channel estimates for precoder determination for DMRS of PDSCH and PDSCH channel. With reference to FIG. 3A, antenna port 2 (ANT2) will have more loss than antenna port 1 (ANT1) because, for example, antenna port 2 uses two switches SP4T and SP2T, but antenna port 1 merely uses one switch SP4T. Similarly, the circuit path distance between antenna port 1 and the PA is smaller than the circuit path distance between antenna port 2 and the PA, with the longer circuit path distance between antenna port 2 and the PA resulting in more routing loss than the circuit path distance between antenna port 1 and the PA; a longer wire generates more loss. So, multiple factors may combine to produce the loss.

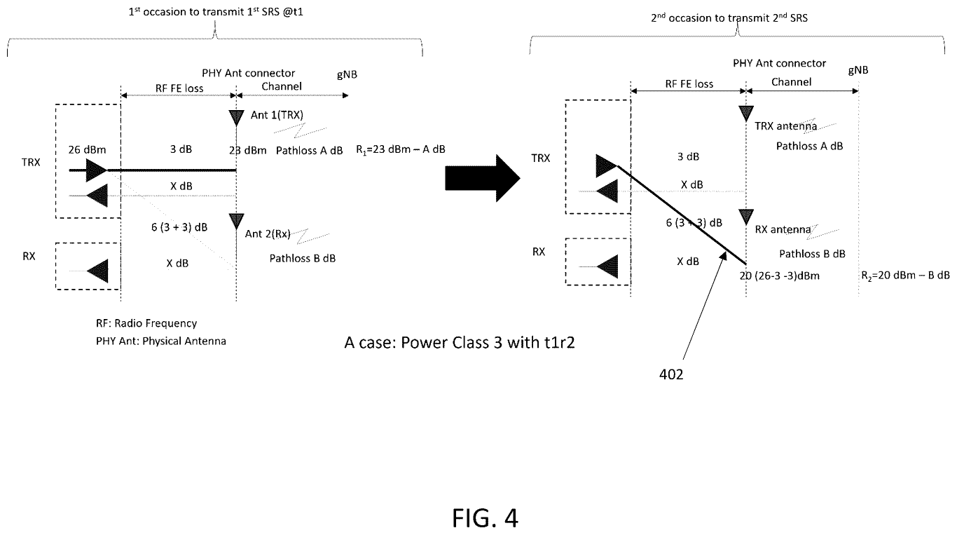

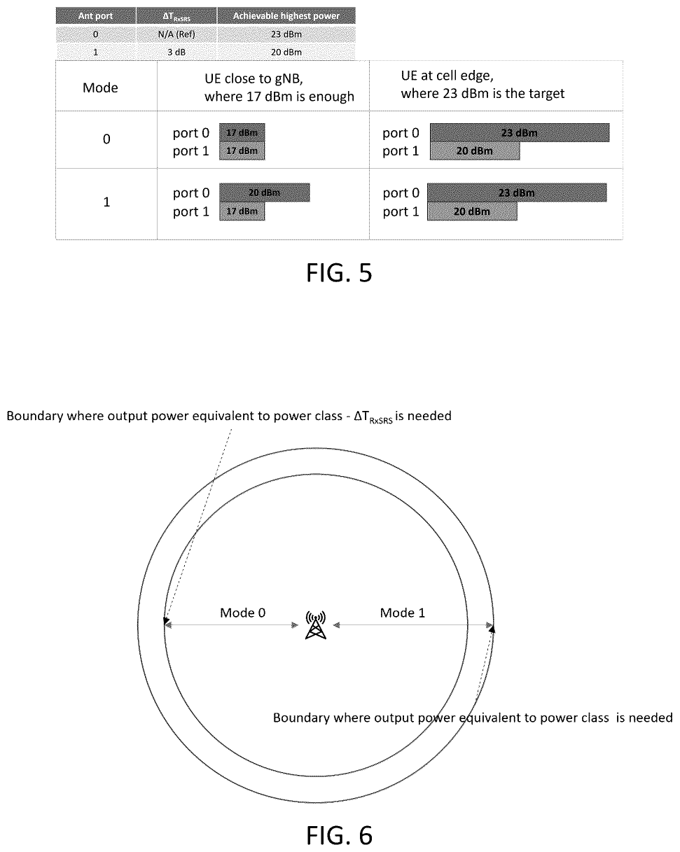

FIG. 4, on the left-hand side, shows a 1st occasion for the UE to transmit a first SRS using the power amplifier of the transmitter at TRX. In this example, using the first antenna port the SRS experiences a 3 dB loss (26 dBm−3 dB=23 dBm), and the gNB, with a pathloss of “A” dB, sees a received power (R1); R1=23 dBm−A dB. FIG. 4, on the right-hand side, shows a 2nd occasion for the UE to transmit a second SRS also using the same power amplifier. In this case the additional routing loss is 3 dB. Thus, as illustrated with FIG. 4, the received power (R2) for the 2nd SRS transmission from UE at gNB is 20 dBm−B (pathloss) dB. R2 unnecessarily includes 3 dB routing loss which may not exist during reception. In order to overcome this issue, it has been proposed that actual additional IL(s) (insertion loss) from main Tx to diversity antenna(s) compared to main TRX chain should be reported to gNB, and a corresponding LS was sent to RAN1 (R4-2303519). Towards the discussion, a following issue (R4-2300215, R4-1813468) was raised. Reporting ΔT_{RxSRS} works in case a UE is at cell edge, where it is likely that UE's PA output power is at maximum from each antenna port. Then, the power imbalance across ports is the same as the imbalance of ΔT_{RxSRS} across ports. Hence, the network can compensate for received power differences from UE's diversity branch by the reported ΔT_{RxSRS}. Related to the corresponding UE behavior, however, is not clear in a case the UE is not at cell edge, i.e., the UE has two choices, compensate for the power by ΔT_{RxSRS} (mode 0) or maintain the power imbalances (mode 1) as shown in FIG. 5; possible UE behavior in terms of output power.

If the UE does not maintain the power imbalances, i.e., try to compensate for the ΔT_{RxSRS} (mode 0) and if gNB uses ΔT_{RxSRS} as error correction factor, the estimated channel may bring even larger errors, while if the UE keep the power imbalance (i.e., mode 1) and if gNB doesn't use ΔT_{RxSRS} as error correction factor, the estimated channel may bring even larger errors as well. Furthermore, when PA output power approaches to close to the achievable maximum power, even Mode 0 may not be able to be realized anymore. Hence, in this case, gNB should apply ΔT_{RxSRS} to error correction process or the UE needs to report configured transmitted power up to the power where the UE can maintain Mode 0, e.g., 20 dBm if ΔT_{RxSRS} for the 2nd SRS transmission is 3 dB for PC3 with t1r2 configuration. Overall, the importance is to enable gNB to correctly know what the UE can do under which condition as well as control the modes properly depending on the condition.

Features as described herein may be used to minimize channel estimation error, not only at a cell edge, but anywhere in the cell. Furthermore, features may also be used to avoid ambiguity between the UE and the gNB regarding to applied UL TX power control method.

There are currently different options to estimate channel with less estimation errors due to ΔT_{RxSRS}. Two modes are provided in order to assist gNB to estimate channel more accurately; Mode 0 and Mode 1. FIG. 6 illustrates usable areas for the respective options.

### Mode 0:

This provides no power imbalance across both port 0 and port 1 as far as a UE is not close to the cell edge. If this Mode 0 is used, gNB shall not use actual ΔT_{RxSRS} per port to correct channel estimation error. Hence, the UE capable of mode 0 does not need to report ΔT_{RxSRS} per port to gNB. It is also noted that this is not feasible when necessary UL TX power is more than or equal to power class−ΔT_{RxSRS} at antenna port. Because if RF Front End loss is e.g., 3 dB for main TRX, this requires PA's output power to be 26 dBm for PC3 (23 dBm at port 0). And it is likely that 26 dBm may be the maximum output power at PA to maintain necessary linearity. In diversity path, however, if ΔT_{RxSRS} is 3 dB, in order to maintain the same power at the main TRX antenna port, the PA's output power needs to be 29 dBm (26 dBm+3 dB) to compensate for ΔT_{RxSRS} of 3 dB, during SRS transmission via port 1. All the UE would not be able to do this since the UE shall be able to meet all the transmitter performance requirements by keeping linearity as well as achieving 29 dBm.

### Mode 1:

This provides fixed power imbalance according to the reported ΔT_{RxSRS} per port. In some cases, the power from ports other than main port (the achievable power is maximum across ports) may be too weak for gNB to estimate channel specifically, if ΔT_{RxSRS} is too large.

Both modes are not always perfect, and the most suitable Mode depends on some other conditions. Hence, depending on the conditions, NW and/or UE need to switch a Mode to the other. Based on following parts of TS 38.213 and TS 38.331 specifications, it seems that the current specifications only allow network to expect UE to conduct mode 0.

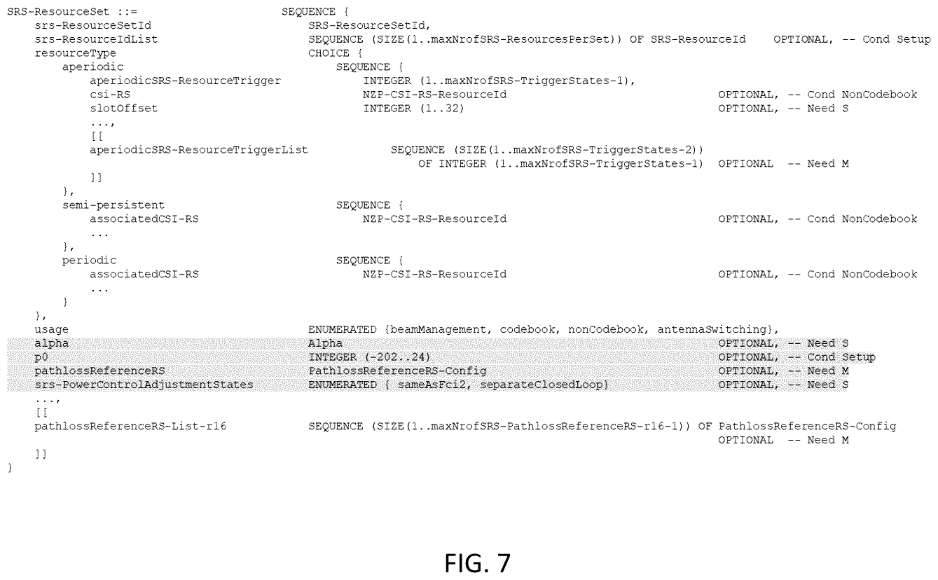

Granularity of power control parameters is defined per SRS resource set. FIG. 7 shows UL SRS set configuration defined in TS 38.331. As can be observed, UL power control parameters are defined at UL SRS resource set level. All UL SRS resources within the same UL SRS resource set share the same the power control parametrization. Therefore, when the UE is configured with single UL SRS resource set, all the antenna ports need to follow the same parameters. Hence, there is no room for NW to adjust UE's power control setting with consideration of the reported actual ΔT_{RxSRS}. TS38.101-1, however, allows a UE to relax at least UE's configured maximum output power lower boundary, i.e., P_{CMAX_L,f,c}, by ΔT_{RxSRS} (Note that currently specified relaxation is not based on the reported actual ΔT_{RxSRS}, but rather based on an expected maximum ΔT_{RxSRS} depending on condition). From TS 38.101-1:

### 6.2.4 Configured Transmitted Power

The UE is allowed to set its configured maximum output power P_{CMAX,f,c} for carrier f of serving cell c in each slot. The configured maximum output power P_{CMAX,f,c} is set within the following bounds:

$${P}_{CMAX \_ L , f , c} \leq {P}_{CMAX , f , c} \leq {P}_{CMAX \_ H , f , c}$$

$$with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( \text{} MAX ( \text{} {MPR}_{c} + Δ {MPR}_{c} , A - {MPR}_{c} ) + {ΔT}_{IB , c} + Δ {T}_{C , c} + Δ {T}_{RxSRS} , P - {MPR}_{c} ) \}$$

$${P}_{CMAX \_ H , f , c} = MIN \{ {P}_{EMAX , c} , {P}_{PowerClass} - Δ {P}_{PowerClass} \}$$

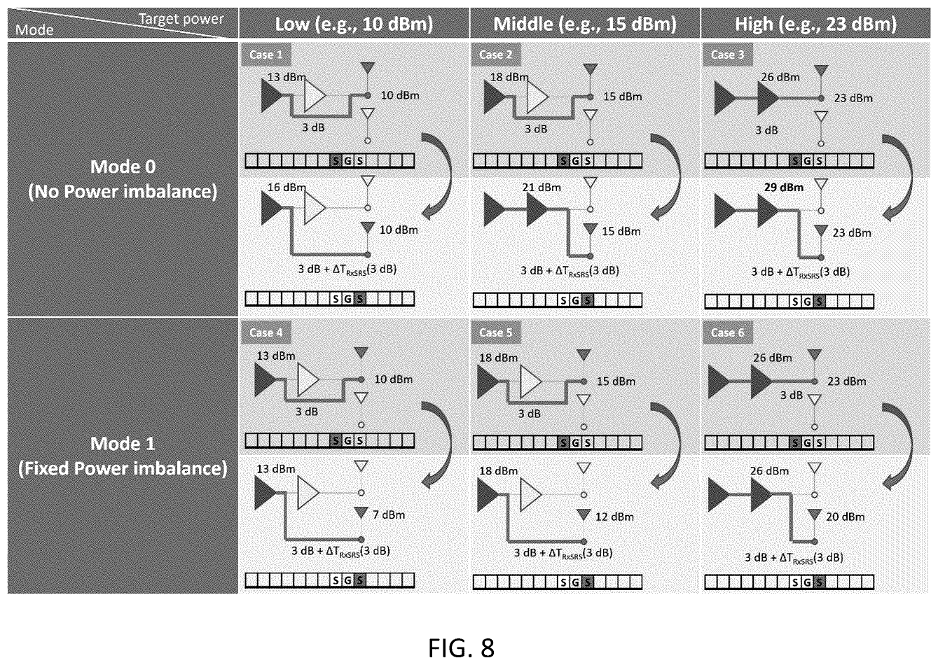

Hence, the UE is allowed to configure transmitted power with consideration of ΔT_{RxSRS} per slot per UE basis, while it is not mandatory for the UE to use exactly the defined ΔT_{RxSRS}, i.e., it is not problem for the UE to use some of ΔT_{RxSRS} or not to use ΔT_{RxSRS} at all if it wants. Hence, it is not clear exact UE behaviors even in higher power range. The UE may use mode 0 or 1. Even if the UE uses one of the modes, it is not clear if the UE uses a part of ΔT_{RxSRS}, e.g., 1 dB out of 3 dB or 3 dB out of 3 dB. In order to obtain the whole picture, expected UE behaviors depending on target powers and modes are shown in FIG. 8; showing relationship of powers at between PA and antenna connector depending on modes (1T2R). It is noted that for mode 0, if UEs strictly follow TS 38.213, i.e., the same power cross ports, the UEs may not transmit more than 20 dBm.

For case 2 of Mode 0, a UE may need to turn on the second (2nd) PA to deliver 21 dBm at PA and 15 dBm at port 0. The power at antenna port is maintained, but the power at PA needs to be increased by 3 dB. Thus, this situation corresponds to relative power requirement in TS 38.101-1, where ΔP=3 dB allows ±4.5 tolerance if we refer to TS38.101-1. The requirement allows UE to have 20 ms to the power setting, while SRS antenna switching gives the UE just one or two symbol to settle down the power at the target value. Hence, it is expected that not all the UEs are able to accurately achieve 21 dBm immediately after the GP (Guard Period) despite the 38.213/38.331 expectation.

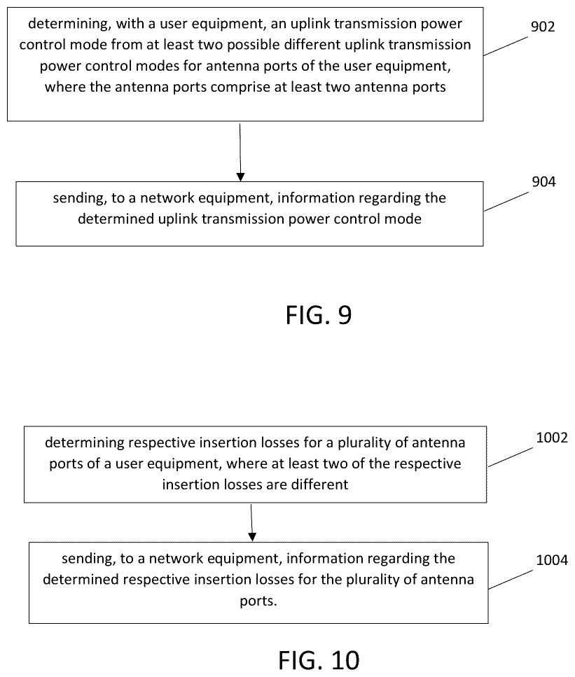

Referring also to FIG. 9 and TS 38.101-1:

### 6.3.4.3 Relative Power Tolerance

The relative power tolerance is the ability of the UE transmitter to set its output power in a target sub-frame (1 ms) relatively to the power of the most recently transmitted reference sub-frame (1 ms) if the transmission gap between these sub-frames is less than or equal to 20 ms.
The minimum requirements specified in Table 6.3.4.3-1 apply when the power of the target and reference sub-frames are within the power range bounded by the minimum output power as defined in clause 6.3.1 and the measured PUMAX as defined in clause 6.2.4.
To account for RF Power amplifier mode changes, 2 exceptions are allowed for each of two test patterns. The test patterns are a monotonically increasing power sweep and a monotonically decreasing power sweep over a range bounded by the requirements of minimum power and maximum power specified in clauses 6.3.1 and 6.2.1, respectively. For those exceptions, the power tolerance limit is a maximum of +6.0 dB in Table 6.3.4.3-1.

TABLE 6.3.4.3-1
Relative power tolerance

| | | All | |
|---|---|---|---|
| | All | combinations of | |
| | combinations of | PUSCH/PUCCH | |
| Power step | PUSCH and | and SRS | |
| DP (Up or | PUCCH | transitions | |
| down) | transitions | between sub- | PRACH |
| (dB) | (dB) | frames (dB) | (dB) |
| ΔP < 2 | ±2.0 (NOTE) | ±2.5 | ±2.0 |
| 2 ≤ ΔP < 3 | ±2.5 | ±3.5 | ±2.5 |
| 3 ≤ ΔP < 4 | ±3.0 | ±4.5 | ±3.0 |
| 4 ≤ ΔP < 10 | ±3.5 | ±5.5 | ±3.5 |
| 10 ≤ ΔP < 15 | ±4.0 | ±7.0 | ±4.0 |
| 15 ≤ ΔP | ±5.0 | ±8.0 | ±5.0 |

(NOTE):
For PUSCH to PUSCH transitions with the allocated resource blocks fixed in frequency and no transmission gaps other than those generated by downlink subframes, DwPTS fields or Guard Periods: for a power step ΔP ≤ 1 dB, the relative power tolerance for transmission is ±0.7 dB.

For case 3 of Mode 0, as mentioned above, the UE is required to increase PA output up to 29 dBm to achieve 23 dBm at port 1. It may not be possible for all of the UEs to perform it. This situation can be generalized in a way that in practice, it is not possible for a UE to perform mode 0 in case the required output power is larger than PC-Max ({actual ΔT_{RxSRS,p}|, p=0, 1, . . . n})=PC−Max(ΔT_{RxSRS,0}, ΔT_{RxSRS,1}, . . . , ΔT_{RxSRS,n}), where p corresponds to port number. Hence, from the UE perspective, if a UE can perform Mode 0 and/or 1 and its applicable conditions should be clearly defined. From network perspective, the network should be able to obtain the UE's capability and its applicable conditions and authority to switch the modes depending on the conditions.

Regarding uplink SRS power control, TS 38.213 defines the UE behavior for the UL SRS power control as follows:
If a UE transmits SRS on active UL BWP b of carrier f of serving cell c using SRS power control adjustment state with index l, the UE determines the SRS transmission power P_{SRS,b,f,c}(i,qₛ,l) in SRS transmission occasion i as:

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ]$$

where,
P_{CMAX,f,c}(i) is the configured UE transmit power defined in [8, TS 38.101-1] and [8-2, TS38.101-2] for carrier f of serving cell c in SRS transmission occasion i
P_{O_SRS,b,f,c}(qₛ) is provided by p0 for active UL BWP b of carrier f of serving cell c and SRS resource set qₛ provided by SRS-ResourceSet and SRS-ResourceSetId; if p0 is not provided, P_{O_SRS,b,f,c}(qₛ)=P_{O_NOMINAL_PUSCH,f,c}(0)
M_{SRS,b,f,c}(i) is a SRS bandwidth expressed in number of resource blocks for SRS transmission occasion i on active UL BWP b of carrier f of serving cell c and μ is a SCS configuration defined in [4, TS 38.211]
α_{SRS,b,f,c}(qₛ) is provided by alpha for active UL BWP b of carrier f of serving cell c and SRS resource set qₛ
PL_{b,f,c}(q_{d}) is a downlink pathloss estimate in dB calculated by the UE using RS resource index q_{d} as described in Subclause 7.1.1 for the active DL BWP of serving cell c and SRS resource set qₛ [6, TS 38.214]. The RS resource index q_{d} is provided by pathlossReferenceRS associated with the SRS resource set qₛ and is either a ssb-Index providing a SS/PBCH block index or a csi-RS-Index providing a CSI-RS resource index
If the UE is not provided pathlossReferenceRS or before the UE is provided dedicated higher layer parameters, the UE calculates PL_{b,f,c}(q_{d}) using a RS resource obtained from the SS/PBCH block that the UE uses to obtain MIB
If the UE is provided pathlossReferenceLinking, the RS resource is on a serving cell indicated by a value of pathlossReferenceLinking
For the SRS power control adjustment state for active UL BWP b of carrier f of serving cell C and SRS transmission occasion i
h_{b,f,c}(i,l)=f_{b,f,c}(i,l), where f_{b,f,c}(i,l) is the current PUSCH power control adjustment state as described in Subclause 7.1.1, if srs-PowerControlAdjustmentStates indicates a same power control adjustment state for SRS transmissions and PUSCH transmissions; or

$${h}_{b , f , c} ( i ) = {h}_{b , f , c} ( i - 1 ) + {\sum }_{m = 0}^{C ( {S}_{i} ) - 1} {δ}_{SRS , b , f , c} ( m )$$

if the UE is not configured for PUSCH transmissions on active UL BWP b of carrier f of serving cell C, or if srs-PowerControlAdjustmentStates indicates separate power control adjustment states between SRS transmissions and PUSCH transmissions, and if tpc-Accumulation is not provided,

Some features as described herein may be used from the UE perspective. Likewise, other features as described herein may be used from the NW perspective.

From the UE perspective, an example may comprise defining at least two (2) power control modes comprising:
Mode 0: UE maintains output powers at the respective antenna connectors the same
Mode 1: UE maintains output powers imbalanced depending on the reported actual ΔT_{RxSRS,p} at the respective antenna connectors.

It should be noted that ΔT_{RxSRS,p} and ΔT_{RxSRS} are both mentioned in the above description. ΔT_{RxSRS} is maximum allowed performance degradation. ΔT_{RxSRS,p}, on the other hand, is the insertion loss at the respective antenna connectors/ports.

In one example, the insertion loss (or routing loss) for one or more of the respective antenna ports (the per port insertion loss) may be reported by the UE to the network only once. This would be the case in most situations. In most cases, it may be expected that that the reported insertion loss per port will not change. So, whenever the UE is configured with mode 1, the UE would typically not need to repeatedly report the per port insertion loss, and the per port insertion loss would merely be reported once. This means that once the UE signaled the values of the per port insertion loss during initial access as UE capability parameters, the UE would typically not need to report the per port insertion loss to the network again. It should also be noted that, in another example, the insertion loss for each of the respective antenna ports (the per port insertion loss) may be reported by the UE to the network more than once such as, for example, if there is a change where it might be desired to be reported to the network at a later time after the first initial reporting.

The insertion loss at each of the respective antenna connectors/ports may be determined in any suitable manner. For example, the insertion loss may be predetermined or may be measured or may be estimated or expected based upon one or more predetermined factors and/or one or more non-predetermined factors. For example, one or more values may be preinstalled in the UE with a predetermination into a program or algorithm, and perhaps supplemented with one or more additional factors. For example, a UE manufacturer may have specific insertion loss values, per antenna port, stored into memory when the UE is manufactured. The insertion loss values may be fixed. The insertion loss values would be different for different models of UEs in most cases. In one type of example embodiment, the program/software may be adapted to modify the insertion loss values stored in the memory based upon one or more factors such as, for example, if the UE regularly and autonomously measures the loss (or a portion of the loss or factor(s) affecting loss) by themselves. For example, temperature may change the insertion loss and, thus, temperature may be used to help determine the insertion loss per antenna port. Also, as mentioned above, switching and circuit path distance may change the insertion loss and, thus, switching and/or circuit path distance may change the insertion loss per antenna port. It should be noted that these are merely examples of some factors which may be used to determine the insertion loss, but are not limiting. More or less factors may be used to determine the insertion loss. In some example embodiments the insertion loss might be referred to as an actual insertion loss, or an expected insertion loss, or an estimated insertion loss, or an approximated insertion loss. However, these are merely names and should not be considered as limiting. The different respective “values” of the insertion losses, per antenna port, being reported to the network may be used as a feature; regardless of how those values are obtained. In one example, the actual insertion loss may be “zero” (0 dB) (or set at “zero”) for port 0, and the actual insertion loss for the other ports may be set relative to that Port 0. The estimated insertion losses, per antenna port, may be determined as noted above and reported to the network. For example, with reference to the table below, with an insertion loss for port 1 of 3 dB, the UE may report ΔT_{RxSRS,p} to the NW; ΔT_{RxSRS,1}=3 dB in this example.

Additionally, or alternatively, an example may comprise introducing a new per antenna port power control concept where a new parameter ΔT_{RxSRS, p} is introduced into the power control formula in order for the UE to adjust the powers depending on the previously reported parameters. This may be introduced into TS 38.213 for example. With the example using the two defined power control modes
For Mode 0: this may comprise that the network (NW) will not consider actual ΔT_{RxSRS,p}
For Mode 1: the output power P_{ref} at antenna port(s) with the least ΔT_{RxSRS,min}=Min {ΔT_{RxSRS,p}|p=0, 1, . . . n} may be the reference,
   For example, if ΔT_{RxSRS,0}=0 dB, ΔT_{RxSRS,1}=3 dB, ΔT_{RxSRS,2}=4 dB, ΔT_{RxSRS,3}=5 dB as illustrated below:

| | Port 0 | Port 1 | Port 2 | Port 3 |
|---|---|---|---|---|
| ΔT_{RxSRS} | 0 dB | 3 dB | 4 dB | 5 dB |
| Power | P_{ref} = P₀ | P₀ − 3 dB | P₀ − 4 dB | P₀ − 5 dB |

With Mode 1, in one example embodiment, the UE may apply a new per antenna port power control concept to mode 1 where a new parameter ΔT_{RxSRS,p} is introduced into power control formula in order for the UE to adjust the powers depending on the parameters previously reported to the gNB.
In another example embodiment with Mode 1, P_{CMAX, f, c, p}, where the UE takes ΔT_{RxSRS,p} into account, may be reported per port, and it is used for power head room (PHR) calculation per port.

If a UE transmits a sounding reference signal (SRS) based on a configuration by SRS-ResourceSet on active UL BWP b of carrier f of serving cell c using SRS power control adjustment state with index l, the UE may determine the SRS transmission power P_{SRS}(i, qₛ, l, p) per antenna port, p, in SRS transmission occasion i as:

$${P}_{SRS , b , f , c} ( i , {q}_{s} , l , p ) = min \{ \begin{matrix}{P}_{CMAX , f , c , p} ( i ) , \\ \begin{matrix}{P}_{O \_ SRS ,} ( {q}_{s} ) + 10 {log}_{10} ( {2}^{μ} \cdot {M}_{b , f , c}^{SRS} ( i ) ) + \\ {α}_{SRS , b , f , c} ( {q}_{s} ) \cdot PL ( {q}_{d} ) + Δ {T}_{RxSRS , p} ( i ) + {h}_{b , f , c} ( i , l )\end{matrix}\end{matrix} \} [ dBm ]$$

where,
P_{CMAX,f,c,p}(i) is the UE configured maximum output power defined in [8, TS 38.101-1], [8-2, TS 38.101-2] and [TS 38.101-3] for antenna port p of carrier f of serving cell c in SRS transmission occasion i
P_{O_SRS,b,f,c}(qₛ) is provided by p0 for active UL BWP b of carrier f of serving cell c and SRS resource set qₛ provided by SRS-ResourceSet and SRS-ResourceSetId
M_{SRS,b,f,c}(i) is a SRS bandwidth expressed in number of resource blocks for SRS transmission occasion i on active UL BWP b of carrier f of serving cell c and μ is a SCS configuration defined in [4, TS 38.211]
α_{SRS,b,f,c}(qₛ) is provided by alpha for active UL BWP b of carrier f of serving cell c and SRS resource set qₛ
PL_{b,f,c}(q_{d}) is a downlink pathloss estimate in dB calculated by the UE using RS resource index q_{d} as described in clause 7.1.1 for the active DL BWP of serving cell c and SRS resource set qₛ [6, TS 38.214]. The RS resource index q_{d} is provided by pathlossReferenceRS associated with the SRS resource set qₛ and is either an ssb-Index providing a SS/PBCH block index or a csi-RS-Index providing a CSI-RS resource index.
ΔT_{RxSRS,p}(i) is the relative implementation loss associated of SRS antenna port p, with respect to primary antenna connector
h_{b,f,c}(i, l) is defined according exisiting specification in TS 38.213 Clause 7.3.1
   and, where the UE may signal, such as via UE capability for example, if the UE supports:
mode 0, or
mode 1, or
both mode 0 and mode 1.

From the network (NW) perspective, an example may comprise introduction of one or more schemes for the network to request and/or configure the UE to switch modes; supported by the UE depending conditions such as channel for example. In addition, the network may be allowed to configure the UE with one or more event triggering conditions that:
enable the UE to inform the NW of a recommended power control mode where:
   the NW re-configures the UE with the mode, and
   the UE may inform the network with information regarding the mode having been enabled
enable the UE to autonomously apply to a more suitable power control mode, where:
   then, the UE may inform the network with information regarding the mode which has been enabled.

With features as described herein, a system may be introduced for the network to request and/or configure the UE to enable one of the power control modes; depending on power modes supported by the UE. In addition, the network may be allowed to configure the UE with event triggering conditions.

In one embodiment, to enable switching between different UL power control methods (mode 0 or mode 1 for example) for UL SRS resource set with usage antenna-switching, a new higher layer UL SRS resource set specific parameter, pc-method-antenna-switching, may be defined.
a. UL SRS resource set specific parameter, pc-method-antenna-switching, may define multiple UL power control methods for SRS antenna switching. For example, the parameter may define two different modes; mode 0 and mode 1. The parameter may define more than two different modes.
b. In one alternative approach, a new higher layer parameter, i.e. pc-method-antenna-switching, for indication of UL power control method for UL SRS antenna-switching may be included as part of TCI-state information.
c. In another alternative approach, higher layer parameter, i.e. pc-method-antenna-switching, can be switched, e.g. from mode 0 to mode 1 and vice versa via a MAC CE or physical layer signaling (e.g. via DCI), where 1-bit information element or codepoint field is need. The 1-bit information element/codepoint field can be defined as follows: ‘0’=apply mode 0 for scheduled/configured UL SRS transmission, ‘1’=apply mode 1 for scheduled/configured UL SRS transmission, ‘void/−’=UE ignores this information element/codepoint field and applies existing mode for scheduled/configured UL SRS transmission.

Please note that “pc-method-antenna-switching” is merely a name given to the parameter in this description. In an alternate example, another different name for the parameter might be used. In an example embodiment, when the UL SRS resource set with usage antenna-switching is configured with pc-method-antenna-switching=mode 0, the network may consider the power per port within a SRS resource set the same across the ports, and do not take into account ΔT_{RxSRS,p} (p=0, 1, . . . n) for channel estimation correction.

In an example embodiment, when the UL SRS resource set with usage antenna-switching is configured with pc-method-antenna-switching=mode 1, the network may consider that the UE may maintain power imbalance across ports depending on the reported actual ΔT_{RxSRS, p}, and take the reported actual ΔT_{RxSRS, p} into account for channel estimation correction.

In an example embodiment, a UE autonomous UL TX power control method switching, for UL SRS with usage antenna-switching, may be defined.

In one example, the UE autonomous mode selection may be configured to be used in conjunction with existing power control mode or independent from them.

In one example, the UE may be configured with multiple UL SRS with antenna-switching specific UL power control triggering conditions. Example embodiments may include, merely for example:
if relation of PHRs becomes or approaches:

$$Max \{ {PHR}_{, f , c , p} \vert p = 0 , 1 , 2 … n \} - Min \{ {PHR}_{, f , c , p} \vert p = 0 , 1 , 2 … n \} \geq X dB$$

where X may be, for example, the UE's Power Class (or achievable maximum power per port across all the ports)—ΔT_{RxSRS,max}=Max{ΔT_{RxSRS,p}|p=0, 1, 2 . . . n}, then the UE may switch from mode 0 to mode 1, else, mode 1 to mode 0. This may be used in case all the parameters other than ΔT_{RxSRS,p} in Power control formula are the same across antenna ports.
if relation of P_{CMAX, f, c, p} becomes or approaches to:

$$X dB \leq Max \{ {P}_{CMAX , f , c , p} \vert p = 0 , 1 , 2 … n \} - Min \{ {P}_{CMAX , f , c , p} \vert , p = 0 , 1 , 2 … n \} ,$$

where X may be, for example, ΔT_{RxSRS,max}=Max{ΔT_{RxSRS,p}|p=0, 1, 2 . . . n}, the UE may switch from mode 0 to mode 1, else, mode 1 to mode 0. Note that the NW may use a larger X than the above examples to avoid frequent switching.

When the UE has autonomously selected one of the UL power control modes for UL SRS antenna switching:
The UE may send out a request message to gNB, such as via MAC CE for example, where the UE recommends the selected power control modes for UL SRS transmission with usage antenna-switching. The request message may consist of at least a following information elements, such as, for example, a recommended power control method=mode 0 or mode 1
The gNB may send out a confirmation message, such as via MAC CE or physical layer signaling (e.g. via DCI) for example, where pc-method-antenna-switching may be either explicitly indicated or a recommended power control mode is confirmed. For example, a one (“1”) bit signaling OK and a zero (“0”) bit signaling not OK.
When the UE receives the confirmation message with either explicit power control mode or the “OK” signaling, the UE may apply the indicated UL power control mode after K-symbol/slots from the reception of the confirmation message.
Otherwise, the UE may apply legacy power control mode or maintain the current method.

When the UE has autonomously selected one of the UL power control modes for UL SRS antenna switching, the UE may send out the completion message that the UE has enabled one of the power control modes depending on the threshold to the gNB, such as, for example, via a MAC CE. The completion message may comprise at least one of the power control mode (0 or 1). Otherwise, the UE may apply legacy power control method or maintain the current mode.

With features as described herein, a non-autonomous type of UE operation may be provided. With features as described herein, an autonomous type of UE operation may be provided. For example, with the autonomous type of UE operation the gNB may send information to the UE with multiple UL SRS with antenna-switching specific UL power control triggering conditions.

UE capability, including which mode(s) that a UE supports, is signaled during initial access. When UE capability is mentioned, it is normally static but, of course, may change. Configurations become possible only after the gNB receives the UE capability. In most cases, the UE would not supply additional report(s) regarding the mode or the loss per port after the UE is configured. An example may comprise at least one of:
1. gNB configuring the UE to use mode 0; or
2. the gNB configuring the UE to use mode 1; or
3. the gNB configuring the UE to use both mode 0 and mode 1 such as, for example, using mode 0 and mode 1 alternatively with the UE selecting the mode.

The gNB may use the reported per port loss to compensate for the lost power when the UE is during mode 1. On the other hand, the gNB does not need to use the reported per port loss when the UE is during mode 0. For mode 0, the insertion losses are not material for the gNB (because the power at the antenna ports is the same and, thus, the network does not need to compensate for a power imbalance), and the per port insertion losses need not be reported to the gNB in regard to mode 0. With mode 1, on the other hand, the UE has power imbalances across the ports, and the UE is able to report those imbalances (per port insertion losses) to the gNB at initial access to help prevent an over-estimate by the gNB regarding a channel.

For the UE autonomous selection case, where the UE can select between mode 0 and mode 1, the UE may report the selected mode to the gNB. However, since the loss per port was previously reported as UE capability at initial access, there normally is no need for the UE to report the values to the gNB again. The gNB may, if mode 0 has been selected, configure to communicate with the UE in view of that selection. The gNB may, if mode 1 has been selected, configure to communicate with the UE in view of that selection. For use with a mode 1 selection, the gNB may send the UE one or more event triggering information. Of course, reselections with the UE and gNB may occur subsequently.

In one example embodiment, an example method may be provided comprising: determining, with a user equipment, an uplink transmission power control mode from at least two possible different uplink transmission power control modes for antenna ports of the user equipment, where the antenna ports comprise at least two antenna ports; and sending, to a network equipment, information regarding the determined uplink transmission power control mode. The determining may comprises receiving a message by the UE from the network to configure the UE for a first mode. The determining may comprise receiving a message by the UE from the network to configure the UE for a different second mode. The determining may comprise receiving a message by the UE from the network to configure the UE for use of both the first mode and the second mode such as, for example, using the modes alternatively with the UE selecting the mode. The determining may comprise determining an uplink transmission power control mode by the user equipment at initial access. The sending of the information to the network from the UE may comprise sending a message to the network that the UE supports mode 0 at initial access. The determining may comprise determining an uplink transmission power control mode by the user equipment at initial access. The sending of the information to the network from the UE may comprise sending a message to the network that the UE supports mode 1 at initial access. The sending of the information to the network from the UE may comprise sending a message to the network that the UE supports mode 0 and mode 1. The sending of the information to the network from the UE may comprise sending a report to the network with the per port insertion loss information. The sending of the information to the network from the UE may comprise sending the network a message indicating which mode, from a plurality of modes, the UE has selected. These are merely some examples of the information which may be sent to the network and should not be considered as limiting. In addition the “sending” may comprises multiple messages at different times. The method may comprise determining an insertion loss for the respective at least two antenna ports, and reporting the determined insertion losses for the respective antenna ports to the network.

The at least two different transmission power control modes may comprise: a first mode where the user equipment provides a substantially same uplink transmission output power for the at least two of the antenna ports; and a second mode where the user equipment provides uplink transmission output powers for the at least two antenna ports which are not substantially the same for the respective at least two antenna ports. In the first mode, the providing of the uplink transmission output power for the ports may comprise maintaining the uplink transmission output power, at each respective port, at a substantially same power. In the second mode, the providing of the uplink transmission output powers for the ports may comprise maintaining the uplink transmission output power, at each respective port, as different from one another. In the second mode, the uplink transmission output powers for the ports may be maintained by the UE according to the report previously sent to the network for the insertion losses. So, for example, if the report of the insertion losses to the network for port 0 is zero (0) and port 1 is 3 dB with mode 1, then the UE may be configured to maintain (or at least approximately maintain) that difference of 3 dB between the two port over time.

Referring also to FIG. 9, in accordance with one example embodiment, a method is provided comprising: determining, with a user equipment, an uplink transmission power control mode from at least two possible different uplink transmission power control modes for antenna ports of the user equipment, where the antenna ports comprise at least two antenna ports as illustrated with block 902; and sending, to a network equipment, information regarding the determined uplink transmission power control mode as illustrated with block 904.

The method may further comprise determining an insertion loss for the respective at least two antenna ports. The at least two different transmission power control modes may comprise: a first mode where the user equipment provides a substantially same uplink transmission output power for the at least two of the antenna ports; and a second mode where the user equipment provides uplink transmission output powers for the at least two antenna ports which are not substantially the same for the respective at least two antenna ports. The second mode may comprise determining an uplink transmission output power performance degradation for the at least two antenna ports. The sending of the information may comprise sending a report in regard to the second mode to the network equipment, where the report comprises information regarding the insertion losses for the respective at least two antenna ports. The information regarding the insertion losses may comprise information relative to a reference output power. The reference output power may comprise the insertion loss, for a first one of the antenna ports, which is less than the insertion loss for a second one of the antenna ports. The sending of the information may comprise an indication that the user equipment is configured to support use of the first mode. The sending of the information may comprise an indication that the user equipment is configured to support use of the second mode. The method may further comprise the user equipment selecting one of the at least two possible different uplink transmission power control modes for use with the antenna ports. The sending of the information may comprise an indication of the selected uplink transmission power control mode. The method may further comprise receiving mode information from the network equipment. The received mode information may comprise information regarding at least one event triggering condition to enable the user equipment to, at least one of: inform the network equipment of a recommended power control mode, or select one of the at least two possible different uplink transmission power control modes for use with the antenna ports. The received mode information may be configured to enable the user equipment to inform the network equipment of a recommended power control mode, and the method may further comprise receiving a message from the network equipment configured for the user equipment to reconfigure to use the recommended power control mode. The method may further comprise the user equipment sending a message to the network equipment that the user equipment has reconfigured to use the recommended power control mode. The received mode information may be configured to enable the user equipment to select one of the at least two possible different uplink transmission power control modes for use with the antenna ports, and the method may further comprise the user equipment sending a message to the network equipment that the user equipment has reconfigured to use the selected transmission power control mode. The method may further comprise receiving, with the user equipment, multiple uplink power control triggering conditions for use with antenna-switching. The method may further comprise using the multiple uplink power control triggering conditions to select one of the at least two possible different uplink transmission power control modes. The method may further comprise receiving, with the user equipment, receiving an uplink sounding resource signal (SRS) resource set parameter, and using the parameter to configure the user equipment to use one of the at least two possible different uplink transmission power control modes. The method may further comprise receiving a message, with the user equipment, with a change of the parameter, and using the changed parameter to reconfigure the user equipment to use a different one of the at least two possible different uplink transmission power control modes.

In accordance with one example embodiment, an example apparatus is provided comprising: at least one processor; and at least one non-transitory memory storing instructions that, when executed with the at least one processor, cause the apparatus to perform: determining, with the apparatus, an uplink transmission power control mode from at least two possible different uplink transmission power control modes for antenna ports of the apparatus, where the antenna ports comprise at least two antenna ports; and sending, to a network equipment, information regarding the determined uplink transmission power control mode.

The instructions, when executed with the at least one processor, may cause the apparatus to perform determining an insertion loss for the respective at least two antenna ports. The at least two different transmission power control modes may comprise: a first mode where the user equipment provides a substantially same uplink transmission output power for the at least two of the antenna ports; and a second mode where the user equipment provides uplink transmission output powers for the at least two antenna ports which are not substantially the same for the respective at least two antenna ports. The second mode may comprise determining an uplink transmission output power performance degradation for the at least two antenna ports. The sending of the information may comprise sending a report in regard to the second mode to the network equipment, where the report comprises information regarding the insertion losses for the respective at least two antenna ports. The information regarding the insertion losses may comprise information relative to a reference output power. The reference output power may comprise the insertion loss, for a first one of the antenna ports, which is less than the insertion loss for a second one of the antenna ports. The sending of the information may comprise an indication that the user equipment is configured to support use of the first mode. The sending of the information may comprise an indication that the user equipment is configured to support use of the second mode. The instructions, when executed with the at least one processor, may cause the apparatus to perform selecting one of the at least two possible different uplink transmission power control modes for use with the antenna ports. The sending of the information may comprise an indication of the selected uplink transmission power control mode. The instructions, when executed with the at least one processor, may cause the apparatus to perform receiving mode information from the network equipment. The received mode information may comprise information regarding at least one event triggering condition to enable the apparatus to, at least one of: inform the network equipment of a recommended power control mode, or select one of the at least two possible different uplink transmission power control modes for use with the antenna ports. The received mode information may be configured to enable the apparatus to inform the network equipment of a recommended power control mode, and where the instructions, when executed with the at least one processor, may cause the apparatus to perform receiving a message from the network equipment configured for the apparatus to reconfigure to use the recommended power control mode. The instructions, when executed with the at least one processor, may cause the apparatus to perform sending a message to the network equipment that the apparatus has reconfigured to use the recommended power control mode. The received mode information may be configured to enable the apparatus to select one of the at least two possible different uplink transmission power control modes for use with the antenna ports, and where the instructions, when executed with the at least one processor, may cause the apparatus to perform sending a message to the network equipment that the apparatus has reconfigured to use the selected transmission power control mode. The instructions, when executed with the at least one processor, may cause the apparatus to perform receiving, with the apparatus, multiple uplink power control triggering conditions for use with antenna-switching. The instructions, when executed with the at least one processor, may cause the apparatus to perform using the multiple uplink power control triggering conditions to select one of the at least two possible different uplink transmission power control modes. The instructions, when executed with the at least one processor, may cause the apparatus to perform receiving, with the apparatus, an uplink sounding resource signal (SRS) resource set parameter, and using the parameter to configure the user equipment to use one of the at least two possible different uplink transmission power control modes. The instructions, when executed with the at least one processor, may cause the apparatus to perform receiving a message, with the apparatus, with a change of the parameter, and using the changed parameter to reconfigure the apparatus to use a different one of the at least two possible different uplink transmission power control modes.

In accordance with one example embodiment, an example apparatus may be provided comprising: means for determining, with a the apparatus, an uplink transmission power control mode from at least two possible different uplink transmission power control modes for antenna ports of the apparatus, where the antenna ports comprise at least two antenna ports; and means for sending, to a network equipment, information regarding the determined uplink transmission power control mode.

In accordance with one example embodiment, an example apparatus may be provided with a non-transitory program storage device readable by an apparatus, tangibly embodying a program of instructions executable with the apparatus for performing operations, the operations comprising: determining, with the apparatus, an uplink transmission power control mode from at least two possible different uplink transmission power control modes for antenna ports of the apparatus, where the antenna ports comprise at least two antenna ports; and sending, to a network equipment, information regarding the determined uplink transmission power control mode.

Referring also to FIG. 10, in accordance with one example embodiment, an example method may be provided comprising: determining respective insertion losses for a plurality of antenna ports of a user equipment, where at least two of the respective insertion losses are different as illustrated with block 1002; and sending, to a network equipment, information regarding the determined respective insertion losses for the plurality of antenna ports as illustrated with block 1004.

The sending of the information may comprise sending a report to the network equipment comprising the determined respective insertion losses. The determining of the respective insertion losses may comprise use of a reference output power. The user equipment may be adapted to use one of at least two uplink transmission power control modes, where the least two uplink transmission power control modes comprise: a first mode where the user equipment is configured to provide a substantially same uplink transmission output power for the antenna ports; and a second mode where the user equipment is configured to provide uplink transmission output powers for the antenna ports which are not substantially the same for the respective antenna ports, where the method further comprises receiving from the network equipment information to use the second mode. The method may further comprise sending a message to the network equipment recommending the second mode. The user equipment may be adapted to use one of at least two uplink transmission power control modes, where the least two uplink transmission power control modes comprise: a first mode where the user equipment is configured to provide a substantially same uplink transmission output power for the antenna ports; and a second mode where the user equipment is configured to provide uplink transmission output powers for the antenna ports which are not substantially the same for the respective antenna ports, where the method further comprises the user equipment selecting one of the modes. The method may further comprise sending a message to the network equipment indicating that the user equipment has selected the second mode. The method may further comprise receiving, from the network equipment, information configured for the user equipment to use to configure an uplink transmission power control mode from as one of at least two uplink transmission power control modes. The method may further comprise receiving, from the network equipment, multiple uplink power control triggering conditions for use with mode switching. The method may further comprise using at least one of the multiple uplink power control triggering conditions to select an uplink transmission power control mode. The method may further comprise receiving, from the network equipment, an uplink sounding resource signal (SRS) resource set parameter, and using the parameter to configure the user equipment to use one of the at least two possible different uplink transmission power control modes. The method may further comprise receiving a message, with the user equipment, with a change of the parameter, and using the changed parameter to reconfigure the user equipment to use a different one of the at least two possible different uplink transmission power control modes.

In accordance with one example embodiment, an example apparatus may be provided comprising: at least one processor; and at least one non-transitory memory storing instructions that, when executed with the at least one processor, cause the apparatus to perform: determining respective insertion losses for a plurality of antenna ports of the apparatus, where at least two of the respective insertion losses are different; and sending, to a network equipment, information regarding the determined respective insertion losses for the plurality of antenna ports.

The sending of the information may comprise sending a report to the network equipment comprising the determined respective insertion losses. The determining of the respective insertion losses may comprise use of a reference output power. The apparatus may be adapted to use one of at least two uplink transmission power control modes, where the least two uplink transmission power control modes comprise: a first mode where the user equipment is configured to provide a substantially same uplink transmission output power for the antenna ports; and a second mode where the user equipment is configured to provide uplink transmission output powers for the antenna ports which are not substantially the same for the respective antenna ports, where the instructions, when executed with the at least one processor, cause the apparatus to perform receiving from the network equipment information to use the second mode. The instructions, when executed with the at least one processor, may cause the apparatus to perform sending a message to the network equipment recommending the second mode. The apparatus may be adapted to use one of at least two uplink transmission power control modes, where the least two uplink transmission power control modes comprise: a first mode where the apparatus is configured to provide a substantially same uplink transmission output power for the antenna ports; and a second mode where the apparatus is configured to provide uplink transmission output powers for the antenna ports which are not substantially the same for the respective antenna ports, where the instructions, when executed with the at least one processor, cause the apparatus to perform selecting one of the modes. The instructions, when executed with the at least one processor, may cause the apparatus to perform sending a message to the network equipment indicating that the apparatus has selected the second mode. The instructions, when executed with the at least one processor, may cause the apparatus to perform receiving, from the network equipment, information configured for the apparatus to use to configure an uplink transmission power control mode from as one of at least two uplink transmission power control modes. The instructions, when executed with the at least one processor, may cause the apparatus to perform receiving, from the network equipment, multiple uplink power control triggering conditions for use with mode switching. The instructions, when executed with the at least one processor, may cause the apparatus to perform using at least one of the multiple uplink power control triggering conditions to select an uplink transmission power control mode. The instructions, when executed with the at least one processor, may cause the apparatus to perform receiving, from the network equipment, an uplink sounding resource signal (SRS) resource set parameter, and using the parameter to configure the apparatus to use one of the at least two possible different uplink transmission power control modes. The instructions, when executed with the at least one processor, may cause the apparatus to perform receiving a message, with the user equipment, with a change of the parameter, and using the changed parameter to reconfigure the apparatus to use a different one of the at least two possible different uplink transmission power control modes.

In accordance with one example embodiment, an example apparatus may be provided comprising: means for determining respective insertion losses for a plurality of antenna ports of the apparatus, where at least two of the respective insertion losses are different; and means for sending, to a network equipment, information regarding the determined respective insertion losses for the plurality of antenna ports.

In accordance with one example embodiment, an example apparatus may be provided with a non-transitory program storage device readable by an apparatus, tangibly embodying a program of instructions executable with the apparatus for performing operations, the operations comprising: determining respective insertion losses for a plurality of antenna ports of the apparatus, where at least two of the respective insertion losses are different; and sending, to a network equipment, information regarding the determined respective insertion losses for the plurality of antenna ports.

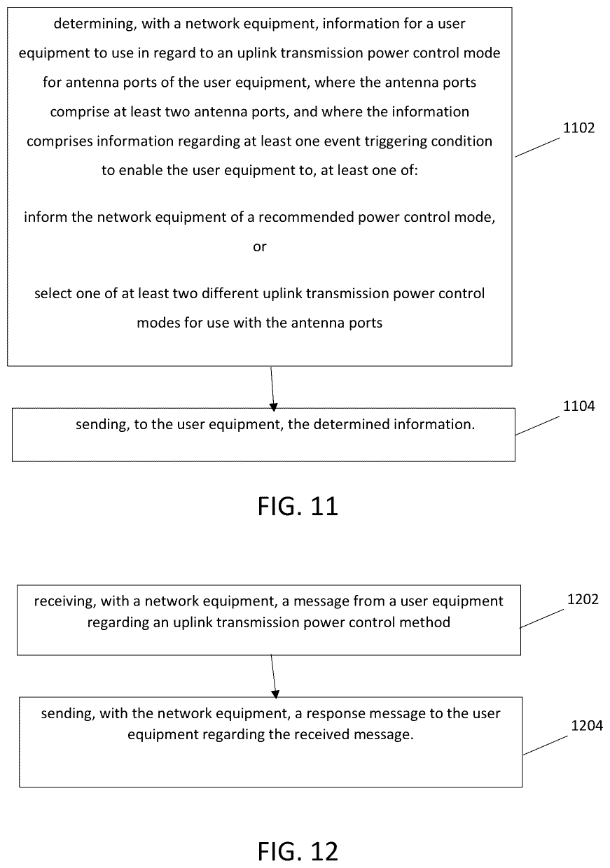

Referring also to FIG. 11, in accordance with one example embodiment, an example method may be provided comprising: determining as illustrated with block 1102, with a network equipment, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the network equipment of a recommended power control mode, or select one of at least two different uplink transmission power control modes for use with the antenna ports; and sending, to the user equipment, the determined information as illustrated with block 1104.

The determined information may be configured to enable the user equipment to inform the network equipment of a recommended power control mode, and the method further comprises sending a message from the network equipment for the user equipment to use the recommended power control mode. The method may further comprise receiving a message from the user equipment indicating that the user equipment has reconfigured to use the recommended power control mode. The determined information may be configured to enable the user equipment to select one of the at least two different transmission power control modes for use with the antenna ports, and the method may further comprise receiving a message from the user equipment indicating that the user equipment has reconfigured to use the selected transmission power control mode. The information may comprise an uplink sounding resource signal (SRS) resource set parameter. The parameter may be configured to be used to by the user equipment to use at least one of the at least two different uplink transmission power control modes. The parameter may be configured to at least partially indicate a UL power control method for UL SRS antenna switching included as part of TCI-state information. The parameter may be sent with a MAC CE or physical layer signaling. The determined information may comprise information regarding the at least two different uplink transmission power control modes. The at least two different uplink transmission power control modes may comprise: a first mode where the user equipment provides a substantially same uplink transmission output power for the at least two antenna ports; and a second mode where the user equipment provides uplink transmission output powers for the at least two antenna ports which are not substantially the same for the respective at least two antenna ports.

In accordance with one example embodiment, an example apparatus may be provided comprising: at least one processor; and at least one non-transitory memory storing instructions that, when executed with the at least one processor, cause the apparatus to perform: determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and sending, to the user equipment, the determined information.

In accordance with one example embodiment, an example apparatus may be provided comprising: means for determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and means for sending, to the user equipment, the determined information.

In accordance with one example embodiment, an example apparatus may be provided comprising a non-transitory program storage device readable by an apparatus, tangibly embodying a program of instructions executable with the apparatus for performing operations, the operations comprising: determining, with the apparatus, information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of: inform the apparatus of a recommended power control mode, or select one of at least two different uplink transmission power control modes for use with the antenna ports; and sending, to the user equipment, the determined information.

Referring also to FIG. 12, in accordance with one example embodiment, an example method may be provided comprising: receiving as illustrated with block 1202, with a network equipment, a message from a user equipment regarding an uplink transmission power control method; and sending, with the network equipment, a response message to the user equipment regarding the received message as illustrated with block 1204. The sending may comprise sending the response message with a MAC CE or a physical layer signaling. The response message may comprise a confirmation message with either an explicit power control mode or an acknowledgement. The method may further comprise receiving a completion message from the user equipment that the user equipment has enabled one of a plurality of power control modes, depending on a threshold, to the network equipment. The method may further comprise sending to the user equipment multiple uplink power control triggering conditions for use with the method. The method may further comprise using the multiple uplink power control triggering conditions to select one of the at least two possible different uplink transmission power control modes. The method may further comprise sending to the user equipment an uplink sounding resource signal (SRS) resource set parameter adapted for the user equipment to use for one of the at least two possible different uplink transmission power control modes. The method may further comprise sending a message to the user equipment with a change of the parameter, where the changed parameter is configured to be used by the user equipment to reconfigure the user equipment to use a different one of the at least two possible different uplink transmission power control modes.

In accordance with one example embodiment, an example apparatus is provided comprising: at least one processor; and at least one non-transitory memory storing instructions that, when executed with the at least one processor, cause the apparatus to perform: receiving, with the apparatus, a message from a user equipment regarding an uplink transmission power control method; and sending, with the apparatus, a response message to the user equipment regarding the received message.

In accordance with one example embodiment, an example apparatus is provided comprising: means for receiving, with the apparatus, a message from a user equipment regarding an uplink transmission power control method; and means for sending, with the apparatus, a response message to the user equipment regarding the received message.

In accordance with one example embodiment, an example apparatus is provided with a non-transitory program storage device readable by an apparatus, tangibly embodying a program of instructions executable with the apparatus for performing operations, the operations comprising: receiving, with the apparatus, a message from a user equipment regarding an uplink transmission power control method; and sending, with the apparatus, a response message to the user equipment regarding the received message.

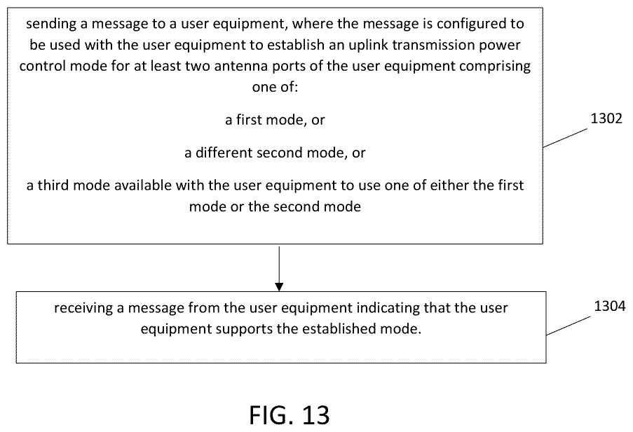

Referring also to FIG. 13, in accordance with one example embodiment, an example method comprises: sending a message to a user equipment as illustrated with block 1302, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and receiving a message from the user equipment indicating that the user equipment supports the established mode as illustrated with block 1304.

In accordance with one example embodiment, an example apparatus is provided comprising: at least one processor; and at least one non-transitory memory storing instructions that, when executed with the at least one processor, cause the apparatus to perform: sending a message to a user equipment, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and receiving a message from the user equipment indicating that the user equipment supports the established mode.

In accordance with one example embodiment, an example apparatus is provided comprising: means for sending a message to a user equipment, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and means for receiving a message from the user equipment indicating that the user equipment supports the established mode.

In accordance with one example embodiment, a non-transitory program storage device readable by an apparatus is provided, tangibly embodying a program of instructions executable with the apparatus for performing operations, the operations comprising: sending a message to a user equipment, where the message is configured to be used with the user equipment to establish an uplink transmission power control mode for at least two antenna ports of the user equipment comprising one of: a first mode, or a different second mode, or a third mode available with the user equipment to use one of either the first mode or the second mode; and receiving a message from the user equipment indicating that the user equipment supports the established mode.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
at least one processor; and
at least one non-transitory memory storing instructions that, when executed with the at least one processor, cause the apparatus at least to:
determine an uplink transmission power control mode from at least two possible different uplink transmission power control modes for antenna ports of the apparatus, where the antenna ports comprise at least two antenna ports; and
send, to a network equipment, information regarding the determined uplink transmission power control mode.

2. The apparatus as claimed in claim 1, wherein the instructions, when executed with the at least one processor, further cause the apparatus to:
determine respective insertion losses for a plurality of antenna ports of the apparatus, where at least two of the respective insertion losses are different; and
send, to the network equipment, information regarding the determined respective insertion losses for the plurality of antenna ports.

3. The apparatus as claimed in claim 1, wherein the at least two different transmission power control modes comprise:
a first mode where the apparatus provides a substantially same uplink transmission output power for the at least two of the antenna ports; and
a second mode where the apparatus provides uplink transmission output powers for the at least two antenna ports which are not substantially the same for the respective at least two antenna ports.

4. The apparatus as claimed in claim 3, wherein the second mode comprises determining an uplink transmission output power performance degradation for the at least two antenna ports.

5. The apparatus as claimed in claim 3, wherein the sending of the information comprises sending a report in regard to the second mode to the network equipment, where the report comprises information regarding insertion losses for the respective at least two antenna ports.

6. The apparatus as claimed in claim 5, wherein the information regarding the insertion losses comprises information relative to a reference output power.

7. The apparatus as claimed in claim 6, wherein the reference output power comprises the insertion loss, for a first one of the antenna ports, which is less than the insertion loss for a second one of the antenna ports.

8. The apparatus as claimed in claim 1, wherein the sending of the information comprises an indication that the apparatus is configured to support use at least one of: a first mode, or a second mode.

9. The apparatus as claimed in claim 1, wherein the instructions, when executed with the at least one processor, further cause the apparatus to select one of the at least two possible different uplink transmission power control modes for use with the antenna ports.

10. The apparatus as claimed in claim 9, wherein the sending of the information comprises an indication of the selected uplink transmission power control mode.

11. The apparatus as claimed in claim 1, wherein the instructions, when executed with the at least one processor, further cause the apparatus to receive mode information from the network equipment.

12. The apparatus as claimed in claim 11, wherein the received mode information comprises information regarding at least one event triggering condition to enable the apparatus to, at least one of:
inform the network equipment of a recommended power control mode, or
select one of the at least two possible different uplink transmission power control modes for use with the antenna ports.

13. The apparatus as claimed in claim 12, wherein the received mode information is configured to enable the apparatus to inform the network equipment of a recommended power control mode, and where the instructions, when executed with the at least one processor, cause the apparatus to receive a message from the network equipment configured for the apparatus to reconfigure to use the recommended power control mode.

14. The apparatus as claimed in claim 13, wherein the instructions, when executed with the at least one processor, further cause the apparatus to send a message to the network equipment that the apparatus has reconfigured to use the recommended power control mode.

15. The apparatus as claimed in claim 1, wherein the instructions, when executed with the at least one processor, further cause the apparatus to receive multiple uplink power control triggering conditions for use with antenna-switching.

16. The apparatus as claimed in 15, wherein the instructions, when executed with the at least one processor, further cause the apparatus to use the multiple uplink power control triggering conditions to select one of the at least two possible different uplink transmission power control modes.

17. The apparatus as claimed in claim 1, where the instructions, when executed with the at least one processor, further cause the apparatus to receive an uplink sounding resource signal (SRS) resource set parameter, and use the parameter to configure the apparatus to use one of the at least two possible different uplink transmission power control modes.

18. The apparatus as claimed in claim 17, wherein the instructions, when executed with the at least one processor, further cause the apparatus to receive a message with a change of the parameter, and use the changed parameter to reconfigure the apparatus to use a different one of the at least two possible different uplink transmission power control modes.

19. A method comprising:
determining, with a user equipment, an uplink transmission power control mode from at least two possible different uplink transmission power control modes for antenna ports of the user equipment, where the antenna ports comprise at least two antenna ports; and
sending, to a network equipment, information regarding the determined uplink transmission power control mode.

20. An apparatus comprising:
at least one processor; and
at least one non-transitory memory storing instructions that, when executed with the at least one processor, cause the apparatus at least to:
determine information for a user equipment to use in regard to an uplink transmission power control mode for antenna ports of the user equipment, where the antenna ports comprise at least two antenna ports, and where the information comprises information regarding at least one event triggering condition to enable the user equipment to, at least one of:
inform the apparatus of a recommended power control mode, or
select one of at least two different uplink transmission power control modes for use with the antenna ports; and
send, to the user equipment, the determined information.
